(19) United States
(12) Patent Application Publication
(10) Pub. No.: US 2023/0086528 A1
(43) Pub. Date: Mar. 23, 2023

(54) HYDROELECTRIC GENERATOR

(71) Applicant: MICROTURBINE CONSULTING LTD, Gloucestershire (GB)

(72) Inventor: Richard Hugh Cameron BENTALL, Gloucestershire (GB)

(73) Assignee: MICROTURBINE CONSULTING LTD, Gloucestershire (GB)

(21) Appl. No.: 17/795,818

(22) PCT Filed: Jan. 27, 2021
(86) PCT No.: PCT/GB2021/050190

§ 371 Date: Jul. 27, 2022

(30) Foreign Application Priority Data
Jan. 27, 2020 (GB) 2001103.7

(51) Int. Cl. F03B 17/06; F03B 13/00

(52) U.S. Cl. CPC F03B 17/062; F03B 13/00

(57) ABSTRACT

The invention relates to a floatable hydroelectric generator (10) for harvesting electrical energy from the flow (R) of water in a river. The generator assembly (10) includes a floatable chassis (12) to which are connected two spaced-apart rotational axles (18). An electrical generator (not shown) is mounted on the floatable chassis (12) and coupled to the rotational axles (18). A chain (20) is connected to the rotational axles (18) via pulley wheels (16). A plurality of water receptacles (22) are fixed to the chain (20), and each being orientated, when submerged, to present their major openings towards an oncoming waterflow direction (R). A plurality of minor openings (24) is provided through a wall of each water receptacle (22). A valve member in the form of a flexible flap (26) is located within each water receptacle (22) for controlling passage of water through said minor openings (24). The flexible flap (26) is adapted to selectively permit flow of water through the minor openings (24) into each water receptacle (22); but substantially prevent flow of water through said minor openings (24) out of each water receptacle (22). The generator assembly (10) of the present invention may be deployed at a desired location within a river—optionally as part of a larger array of such assemblies—to generate electricity on a substantially continuous basis.

The present invention relates to a hydroelectric generator and particularly, though not exclusively, to a floatable hydroelectric generator for harvesting electrical energy from the flow of water in a river. Aspects of the present invention relate to a hydroelectric generator assembly, to a method of generating hydroelectric power and to a hydroelectric turbine assembly.

As concerns regarding the impact of climate change escalate, there is an increasing demand for clean, renewable sources of electrical energy. Progress has been made in terms of reducing global reliance on fossil fuels. For example, according to published statistics, the EU has reduced its greenhouse gas emissions by 23% between 1990 and 2018—i.e. during a period where the EU's economy grew by 61%. The EU's Renewable Energy Directive (2018/2001/EU) which entered into force in December 2018 sets binding targets for the EU to fulfil at least 32% of its total energy needs from renewable energy sources.

However, concerns have been expressed that population growth coupled with increasing global energy demands means that the pace of progress is insufficient to meet longer term targets for achieving carbon-neutral economies. Indeed, throughout 2019 several governments have declared national climate change emergencies to demonstrate that tackling climate change is now viewed as a political priority. Additional challenges exist in terms of persuading industrial and so called third-world countries that the steps required to tackle climate change are economically viable.

Hydropower is the EU's largest renewal energy resource. For example, in 2018 hydropower capacity was estimated to be 252 GW compared with 190 GW and 127 GW for wind and solar power, respectively. However, hydropower typically requires large-scale hydroelectric dams to be built to enable water to be directed through turbines in a controlled manner to maximise energy production. Hydroelectric dams are huge infrastructure projects requiring years of planning and significant investment. They may also have detrimental impacts on the surrounding environment. Hydroelectric dams may be located hundreds of miles away from where the produced electricity is required, thereby necessitating costly distribution networks.

In recognition of the challenges posed by climate change, the inventor of the present invention has devised a novel hydroelectric generator system which overcomes, or at least ameliorates, the financial, planning, logistical and environmental issues associated with traditional hydroelectric power schemes. In doing so, the hydroelectric generator apparatus of the present invention is able to more easily access the immense energy generating potential available from the world's rivers in a cost-effective and scalable manner.

According to a first aspect of the present invention there is provided a hydroelectric generator assembly comprising:
(i) a floatable chassis;
(ii) at least two spaced-apart rotational axles attached to the floatable chassis, each adapted to remain, in use, above the surface of a flowing body of water;
(iii) an electrical generator mounted on the floatable chassis and coupled to at least one of the rotational axles;
(iv) an endless loop connected to the rotational axles;
(v) a plurality of water receptacles fixed to the endless loop, and each being orientated, when submerged, to present major openings towards an oncoming waterflow direction;
(vi) a plurality of minor openings being provided through a wall of each water receptacle;
(vii) a valve member located on each water receptacle for controlling passage of water through said minor openings;
   wherein the valve member is adapted to selectively permit flow of water through said minor openings into each water receptacle but substantially prevent flow of water through said minor openings out of each water receptacle.

Optionally, the floatable chassis is supported in the water by at least two parallel buoyant hulls arranged side by side.

Optionally, each water receptacle is provided with at least one concave inner surface and at least one convex outer surface.

Optionally, said plurality of minor openings are in the form of an array of apertures formed through a portion of the water receptacle between its said inner and outer surfaces.

It will be appreciated that the plurality of minor openings will be most effective if they are positioned at the part of each water receptacle which, during its cycle around the rotational axles, first impacts against the waterline as it enters the water. Such an optimal positioning of the minor openings will reduce the initial surface area contact, and hence resistance, between the water's surface and the water receptacle as the water receptacle enters the water. Additionally, as water enters the water receptacle via the minor openings, the increasing weight of the water therein applies a downward assistive force to the water receptacle thus easing its submergence below the air/water interface.

Optionally, the valve member comprises a flap hingeably attached to an interior surface of its water receptacle and moveable between: (i) a first position in which it covers said minor openings to cause flow of water therethrough to be prevented; and (ii) a second position in which said minor openings are uncovered to permit flow of water therethrough.

It will be appreciated that the position of the flap within the water receptacle will be dependent upon the direction of the net water pressure applied to flap at any given time. The orientation of each water receptacle during the portion of its return cycle—i.e. above the waterline between its exit and entry points—ensures that the flap naturally hangs down under the action of gravity and hence moves away from the minor openings.

Optionally, an edge of the flap is attached to the water receptacle proximate an edge of its major opening.

Optionally, the flap is attached to the water receptacle proximate the edge of its major opening which is most distant from the endless loop.

Optionally, the flap comprises a flexible sheet of material.

It will be appreciated that a flexible/deformable sheet of material may provide an effective seal against the minor openings whilst minimising unnecessary weight and maintenance requirements.

Optionally, pulley wheels are attached to opposite ends of each rotational axle.

Optionally, the endless loop comprises a chain, belt or cable which engages with, and transfers movement to, each pulley wheel and its associated axle.

Optionally, a substantially U-shaped channel is attached to the floatable chassis and adapted to remain, in use, at least partially below the surface of a flowing body of water.

Optionally, a base of the U-shaped channel is located beneath each submerged water receptacle, and its opposed side walls extend above the surface of a flowing body of water.

Optionally, the width of the U-shaped channel at both an upstream entrance and a downstream exit thereof is larger than its width at an interim portion between said upstream entrance and downstream exit.

It will be appreciated that the U-shaped channel therefore defines a flow path for a flowing body of water which exhibits a venturi effect serving to increase the velocity of water entering the submerged water receptacles. Advantageously, the U-shaped channel also provides protection against turbulent flow of water caused by, for example, water passing over rocks, pebbles or other undulations on a riverbed.

Optionally, the floatable chassis is provided with a tether for anchoring the hydroelectric generator in desired location within a flowing body of water.

According to a second aspect of the present invention there is provided a method of generating hydroelectric power, comprising:
(i) deploying a hydroelectric generator assembly of the first aspect to a desired location within a flowing body of water;
(ii) tethering said hydroelectric generators at said desired location;
(iii) permitting water to flow into a plurality of submerged water receptacles and thereby close the valve members located therein and thus prevent flow of water through said minor openings out of each water receptacle;
(iv) transferring force to the endless loop causing it, and its associated rotational axles, to rotate; and
(v) causing the electrical generator to convert the kinetic energy imparted on the axles, via the water receptacles and endless loop, into electricity.

According to a third aspect of the present invention there is provided a hydroelectric turbine or generator assembly for generating electricity from a waterflow, for example a river, the turbine assembly comprising: a turbine module wherein the turbine module comprises two spaced-apart rotational axles; and an endless loop connected to the rotational axles wherein a plurality of water receptacles are fixed to the endless loop and each being orientated, when submerged, to present major openings towards an oncoming waterflow direction; a flywheel comprising a drive shaft mechanically coupled to each rotational axle; and a generator comprising a generator shaft wherein the generator shaft is coupled to the flywheel such that rotation of the flywheel drives the generator shaft.

Optionally, the flywheel may be positioned longitudinally at a mid-point between the two spaced-apart rotational axles.

Optionally, the assembly may comprise a central hull and two outboard hulls positioned on opposing sides of the central hull and respective gaps may be defined between the respective outboard hulls and the central hull. A turbine module for generating electricity may be located in each gap.

Optionally, the central hulls and outboard hulls may be elongate and the elongate hulls may be oriented substantially parallel relative to each other.

Optionally, the outboard hulls may be pivotably mounted to the central hull such that the outboard hulls are moveable between a deployed position in which the outboard hulls are positioned outboard of the central hull and a stored position in which the outboard hulls are positioned generally above or in an upward direction relative to the central hull such that the overall footprint of the hulls is reduced when in the stored position.

Optionally, the flywheel and generator are mounted in the central hull. The drive shaft may extend from opposing side walls of the central hull towards the respective outboard hulls to couple the flywheel to the endless loop.

Optionally, the assembly may comprise two turbine modules and each turbine module may by supported in the respective gap between the outboard hull and the central hull. As such, the each set of two-spaced apart rotational axles and endless loop may be supported in respective gaps between the outboard hull and the central hull. There may be two sets of two-spaced apart rotational axles and endless loops such that one set of the two-spaced apart rotational axles and endless loop are located in each gap.

Optionally, a drive chain may couple each rotational axle to a flywheel gear on the drive shaft.

Optionally, each drive chain may be coupled to a drive gear on each rotational axle. The gear ratio between the drive gear and the flywheel gear may be between approximately 10:1 and 50:1.

Optionally, a flywheel belt may couple the flywheel to the generator shaft. Alternatively, a gear box and/or chain may couple or mechanically link the flywheel to the generator shaft.

Optionally, the flywheel belt may extend at least partially around an external surface of the flywheel and the flywheel belt may be coupled to a generator gear.

Optionally, a gear ratio from the flywheel to the generator gear is equal to or greater than approximately 10:1.

Optionally, a starter motor may be configured to apply a starter torque to the flywheel and turbines to rotate the flywheel and turbines of the turbine drive system. The generator may be the starter motor.

Optionally, at least one of the outboard hulls may comprise an electrolysis unit for producing hydrogen.

Optionally, at least one of the outboard and central hulls comprises a battery array. The battery array may be configured to provide a drive torque to the endless loop to drive the water receptacles to move the turbine assembly through water, in use. As such, the battery array may provide a drive torque to the endless loop to operate the hull structure and hydroelectric apparatus as a water craft. The drive torque may be a torque applied to the generator shaft by applying electrical power to the generator.

Further features and advantages of the first, second and third aspects of the present invention will become apparent from the claims and the following description.

An embodiment of the present invention will now be described by way of example only, with reference to the following drawings, in which:—

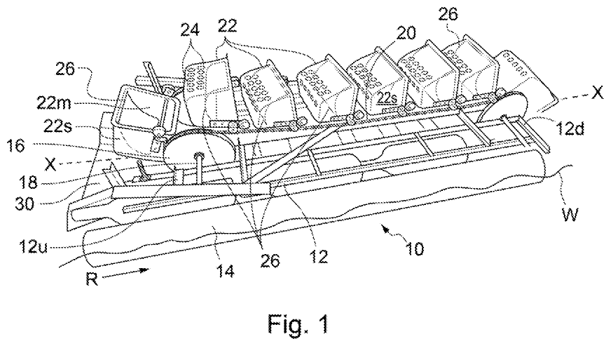

FIG. 1 is a side view of an embodiment of a hydroelectric generator apparatus;

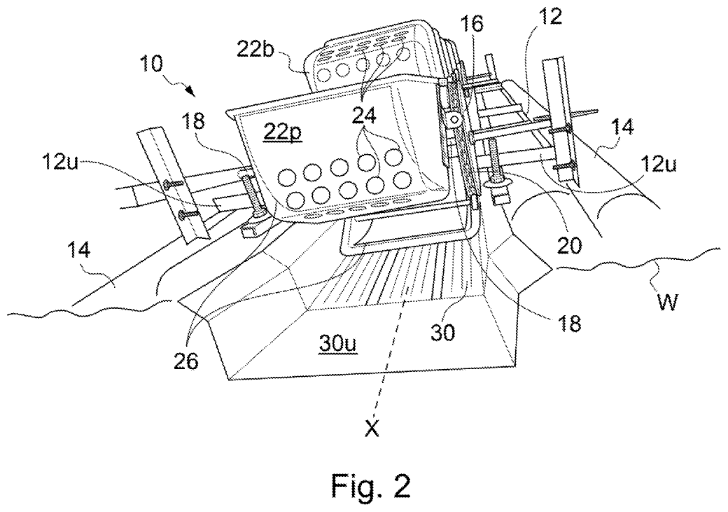

FIG. 2 is an end view of the hydroelectric generator apparatus of FIG. 1;

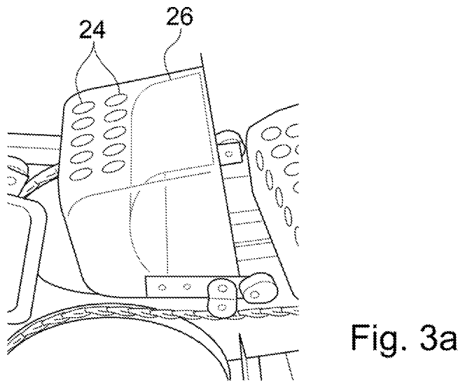

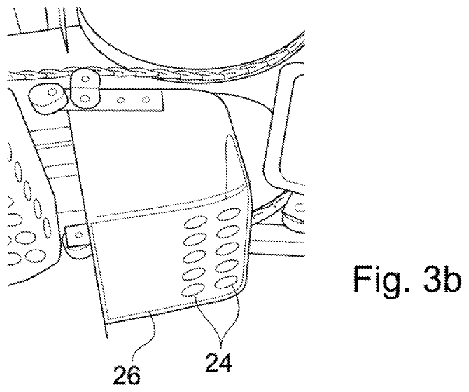

FIG. 3a is a partial view showing a water receptacle and associated flap above the waterline;

FIG. 3b is a partial view showing a water receptacle and associated flap below the waterline;

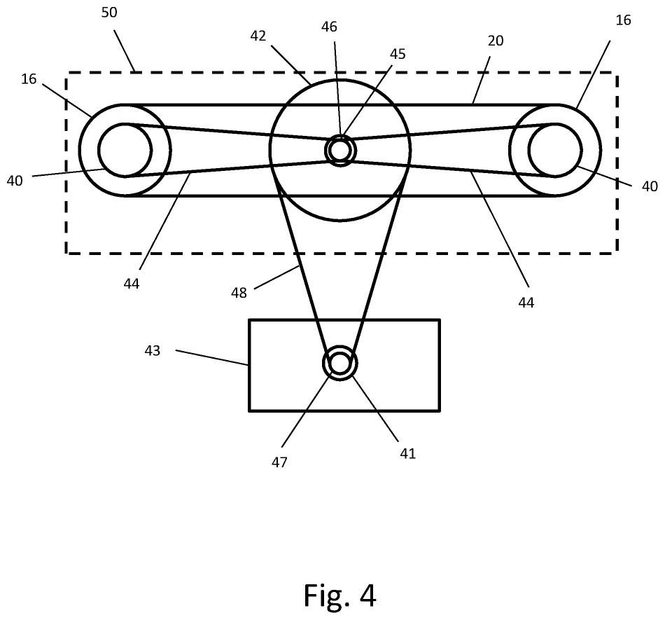

FIG. 4 is a schematic side view of a drive system for use with the hydroelectric generator apparatus of FIG. 1;

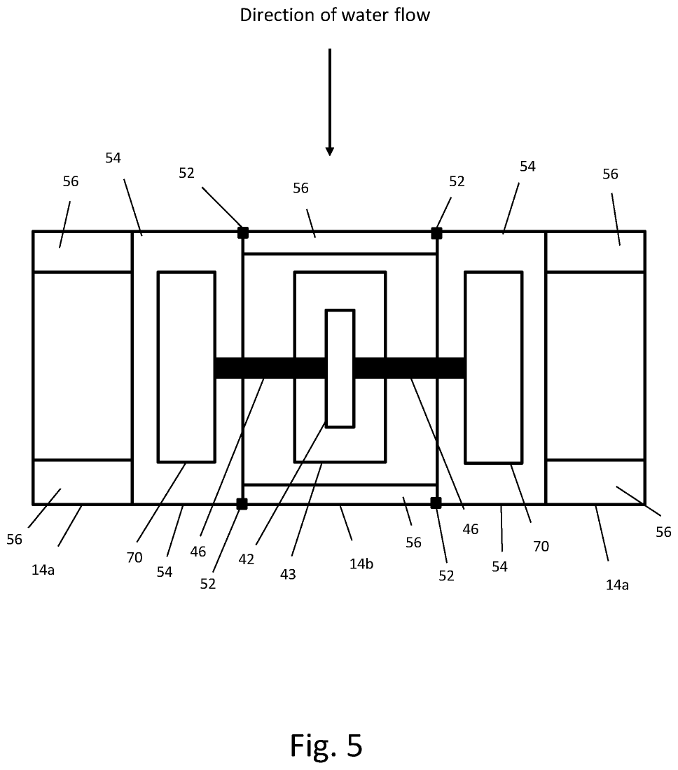

FIG. 5 is a schematic plan view of a trimaran hull structure suitable for use with the hydroelectric generator apparatus of FIG. 1; and

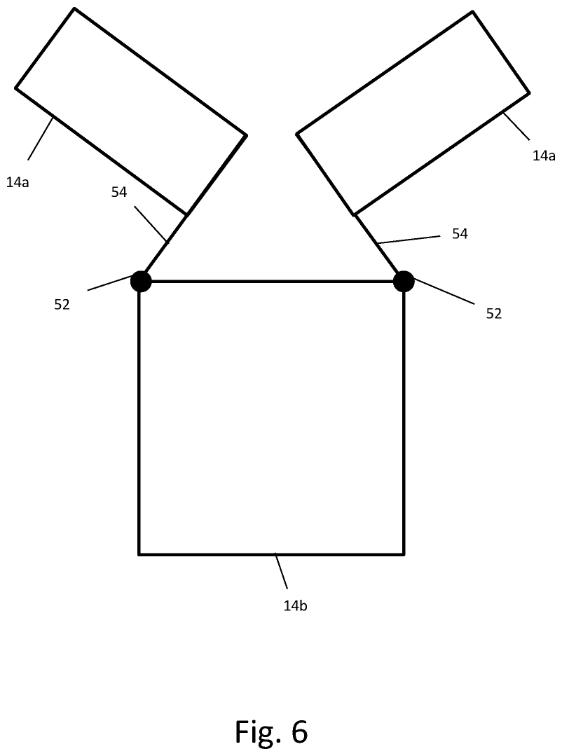

FIG. 6 is a schematic end view of the trimaran hull structure of FIG. 5 in a stored configuration with the turbine modules removed.

A hydroelectric generator apparatus 10 according to a first embodiment is shown in FIGS. 1 and 2. The hydroelectric generator apparatus 10 comprises an elongate chassis 12 supported by a pair of similarly elongate buoyant hulls 14 arranged laterally with respect to a central longitudinal axis, X. Two opposed pairs of cogged pulley wheels 16 are attached to the chassis 12 via laterally extending rotational axles 18. The two cogged pulley wheel pairs 16 are aligned longitudinally on the chassis 12 and spaced apart such that each is located proximate respective opposite upstream and downstream ends 12u, 12d of the chassis 12.

A taught chain 20 is connected, in an endless loop, around the longitudinally aligned cogged pulley wheels 16 of each pulley wheel pair 16. An electrical generator (not shown) is mounted on the chassis 12 and coupled to one or both of the rotational axles 18. The chassis 12, the pulley wheel pairs 16, the laterally extending rotational axles 18, and the taught chain 20 are each arranged to remain above the operational waterline W of the elongate buoyant hulls 14.

A series of water receptacles 22 is connected to each chain 20 and arranged in series, and regularly spaced, around the circumference of the endless loop. In the particular embodiment of FIG. 1, each concave water receptacle 22 takes the form of a generally rectangular container having a base 22b, four side walls 22s, and a major opening 22m. One of the side walls 22p (see FIG. 2) is provided with an array of perforations 24 over its bottom half. The array of perforations also extends partially onto the base 22b of each water receptacle 22, as best shown in FIG. 2.

Each water receptacle 22 is connected to the chains 20 proximate opposite peripheral corners of its major opening 22m; and is arranged in a fixed orientation relative to the chains 20. The fixed orientation is such that: (i) the plane of the major opening 22m of each water receptacle 22 extends substantially radially relative to the rotational axles 18 as it moves around the respective pulley wheels 16; and (ii) the perforated side wall 22p of each water receptacle 22 is the side wall 22s which is always most distant from the rotational axles 18.

A flap of flexible material 26 is attached internally along the peripheral edge of each major opening 22m which corresponds to the perforated side wall 22p. The flap of flexible material 26 is shaped and dimensioned to substantially match the contours and width of the perforated side wall 22p; but it is longer than the depth dimension of the perforated side wall 22p. The flap of flexible material 26 acts as a valve member, the purpose and functioning of which is described in further detail below.

A substantially U-shaped channel 30 is connected to the underside of the chassis 12 between the laterally arranged buoyant hulls 14, to define a passageway for the water receptacles 22. The side walls and base of the upstream end 30u of the U-shaped channel 30 each diverge at an angle (of approximately 15 degrees and 5 degrees, respectively) to provide a flared inlet for water, W. The side walls and base of the downstream end (not shown) of the U-shaped channel 30 is similarly angled to provide a flared outlet. The purpose and function of the U-shaped channel 30 is described in further detail below.

In use, the hydroelectric generator apparatus 10 of FIGS. 1 and 2 is deployed onto a river, or other body of flowing water, to generate electricity. In some embodiments, the hydroelectric generator apparatus 10 is tethered to the riverbed in a manner causing it to self-orientate itself with the direction and depth of the water flow at any given location.

As a consequence of the pulley wheel pairs 16 each being arranged to remain marginally above the operational waterline W of the elongate buoyant hulls 14, the water receptacles 22 connected to the chain 20 also remain above the waterline during more than 50% of their cycle, i.e. as shown in FIG. 3a. However, the extent to which the water receptacles 22 extend radially relative to the chain 20 is such that they are substantially submerged for the remainder of their cycle, i.e. as shown in FIG. 3b. When submerged, the major opening 22m of each water receptacle 22 is presented upstream against the oncoming waterflow direction. The oncoming water fills each submerged water receptacle 22 and exerts a force in the direction of its base 22b. The cumulative forces applied to each submerged water receptacle 22 impart a translational movement of the chain 20 along the flow direction R indicted in FIG. 1. This in turn imparts a rotational movement to each cogged wheel 16, through its connected rotational axles 18, which is then converted to electricity via the coupled electrical generator (not shown).

The continued operation and efficiency of the hydroelectric generator apparatus 10 is improved by the inclusion of an array of perforations 24 formed over the side wall 22p and base 22b of each water receptacle 22. Since the side wall 22p and base 22b surfaces of each water receptacle 22 are first to impact against the waterline W as a water receptacle 22 is being submerged, the perforations 24 reduce the surface area contact and allow water to pass therethrough into the water receptacle 22. The structure of the water receptacles 22 thereby reduce entry resistance at the air/water interface proximate the upstream end of the chassis 12u. As water enters each water receptacle 22 via the perforations 24, the increasing weight of the water therein applies a downward assistive force to the water receptacle 22 thus easing its submergence below the air/water interface.

Similarly, as the water receptacle 22 exits the water proximate the downstream end of the chassis 12d, water is able to drain through the perforations 24 and hence reduce exit resistance at the air/water interface. In particular, the perforations 24 provide a pathway for air and hence avoid, or at least minimise, the formation of a vacuum which would otherwise resist movement of each receptacle upwards through the air/water interface. It will therefore be appreciated that the existence and positioning of the perforations 24 provide a dual benefit for easing entry and exit of each water receptacle 22 into and out of the water.

As water enters each water receptacle 22 via its perforations 24, the flap of flexible material 26 is forced away from the perforated side wall 22p via its internal hinge-like connection along the peripheral edge of its major opening 22m. Conversely, as water enters each water receptacle 22 via its major opening 22m, the incoming water pressure forces the flap of flexible material 26 back against the perforated side wall 22p and base 22b to provide a seal against water egress through the perforations 24. In essence, the flap of flexible material 26 defines an autonomous one-way valve member which selectively permits flow of water through the perforations 24 into each water receptacle 22 (i.e. during the part of the cycle in which each water receptacle 22 first contacts the operational waterline W), whilst selectively (i.e. during the part of the cycle in which each water receptacle 22 is submerged as shown in FIG. 3b) preventing flow of water through the perforations 24 out of each water receptacle 22.

By closing the valve member whilst each water receptacle 22 is submerged—as shown in FIG. 3b—its internal surface area is maximised as is the cumulative force applied against the base wall 22b of all submerged water receptacles 22. By opening the valve member as each water receptacle 22 transitions at the air/water interface, its internal surface area is automatically minimised, as is its transition resistance.

Another feature of the invention which contributes to the continued operation and efficiency of the hydroelectric generator apparatus 10 is the inclusion of the U-shaped channel 30 connected to the underside of the chassis 12 and interposed between the buoyant hulls 14. In use, the base of the U-shaped channel 30 is positioned below the operational waterline W of the buoyant hulls 14, whilst its side walls may extend partially above the operational waterline. The U-shaped channel 30 therefore defines a flow path for water passing beneath the chassis 12, and a passageway for translational movement of each submerged water receptacle 22.

The flared inlet angle of the upstream end 30u of the U-shaped channel 30 exhibits a venturi effect serving to increase the velocity of flowing water at the point where it enters each submerged water receptacle 22. The 15 degree side wall angle, and 5 degree base wall angle, combine to increase the volume of water per unit time passing through the U-shaped channel 30, thus increasing the cumulative force transferred to the rotational axles 18 and the electrical generator (not shown) coupled thereto.

Turning now to FIG. 4 there is shown a schematic side view of a drive system 50 for use with the hydroelectric generator apparatus 10. The water receptacles 22 have been omitted in FIG. 4 for clarity. However, the skilled reader will understand that the water receptacles 22 would be mounted to the chain 20 as described above.

As shown in FIG. 4 the drive system 50 comprises the pair of aligned cogged pulley wheels 16 located at opposing ends of the hydroelectric generator apparatus 10 and a flywheel 42. The flywheel 42 may be mounted on the chassis 12 (not shown in FIG. 4) or alternatively within a hull 14 as is described in further detail below. The flywheel 42 is aligned longitudinally substantially at a mid-point between the pulley wheels 16 such that the flywheel 42 is located at a mid-point of the chassis 12. This is beneficial as mounting the flywheel 42 at a central location within the drive system 50 improves the balance of the hydroelectric generator apparatus 10. The flywheel 42 is mounted on a drive shaft 46 such that rotation of the drive shaft 46 causes the flywheel 42 to similarly rotate.

Each pulley wheel 16 is mechanically coupled to the flywheel 42 via respective drive chains 44. The drive chains 44 are each coupled to a drive gear 40 mounted to the respective pulley wheels 16 such that rotational movement of the chain 20 resulting from the cumulative force applied to the chain 20 via the water receptacles 22 is transferred to the drive gear 40 and thus drive chains 44. Both drive chains 44 are connected to the drive shaft 46 via a flywheel gear 45 such that movement of the chain 20 as a result of the cumulative force applied to the chain 20 by the water receptacles 22 induces rotational movement of the drive shaft 46 and thus flywheel 42.

As shown schematically in FIG. 4 the drive gear 40 has a larger circumference, and therefore more gear teeth, than the flywheel gear 45 mounted on the drive shaft 46. The gear ratio between the drive gear 40 to the flywheel gear 45 may be between about 10:1 and 50:1. The gearing between the drive gear 40 and flywheel gear 45 beneficially allows the flywheel 42 to be rotated at a relatively high rotational speed compared to the relatively low rotational speed of the chain 20 and thus drive gear 40. For example, the drive gear 40 may be rotated at between about 1 rpm to 10 rpm which would in turn cause the flywheel 42 to be rotated at between about 100 rpm and 500 rpm depending on the gearing ratio.

The flywheel 42 is coupled to an electrical generator 43 via a flywheel chain or belt 48. The flywheel belt 48 is coupled to the flywheel 42 and to the generator drive shaft 41. As such, the generator drive shaft 41 is directly driven by the flywheel belt 48. The flywheel belt 48 may extend at least partially around the outer circumference of the flywheel 42. The flywheel belt 48 may engage and grip the outer edge of the flywheel 42 or alternatively the flywheel chain may engage teeth (not shown) located on the outer edge of the flywheel 42 such that rotation of the flywheel 42 drives the flywheel belt 48. The flywheel belt 48 may further engage a generator gear 47 coupled to the generator drive shaft 41. The gear ratio between the flywheel 42 and the generator gear 47 may be about 10:1. As such, the flywheel 42 may drive the generator drive shaft 41 at between about 1000 rpm and 5000 rpm.

The skilled reader will understand that the aforementioned gear ratios are by way of example only and the exact gearing will be selected in dependence on the river conditions and generator size. Furthermore, the skilled reader would understand that a gearbox arrangement or the like may be used in place of the flywheel belt 48 to couple the flywheel 42 to the generator 43. Alternatively, a combination of a gearbox and a belt or chain could be used to couple the flywheel 42 to the generator drive shaft

The centrally mounted flywheel 42 may weigh in excess of 100 kg with the majority of the weight distributed close to the outer circumference such that the flywheel 42 has a relatively large moment of inertia. The large moment of inertia is beneficial as the rotational momentum of the drive system 50 is increased by the flywheel 42 such that the rotational momentum of the drive system 50 can overcome the load on the generator drive shaft 41 due to electrical loads on the generator 43. The overall inertia of the drive system 50 may be further increased by adding weights or ballast to each water receptacle 22. Adding ballast to each water receptacle 22 would beneficially further increase the overall inertia of the drive system 50.

The drive system 50 may further comprise a starter motor (not shown). The starter motor may be used to overcome the initial inertia of the drive system 50 to get the water receptacles 22 moving through the water and furthermore assist in spinning the flywheel 42 up to its operational speed. A clutch system may be positioned between the generator gear 47 and the generator drive shaft 41 such that when the drive system 50 of the hydroelectric generator apparatus 10 is initially started the load of the generator 43 may be disengaged from the drive system 50. This is beneficial as it will reduce the overall inertia required to be overcome by the starter motor and flow of water in order to get the chain 20 and flywheel 42 rotating at the operating speeds.

Once the drive system 50 is rotating at the target operational speed the clutch system may be engaged such that the load of the generator 43 is applied to the generator shaft 41 and the drive system 50 may start to drive the generator shaft 41 to generate electricity.

In an alternative embodiment the generator 43 may act as the starter motor. In this embodiment the generator 43 may be a permanent magnet generator that is fed electricity such that the generator 43 acts as a motor. When the generator 43 acts as a motor the generator 43 may apply a drive torque to the generator drive shaft 41 which may in turn apply a torque to the flywheel 42 thereby assisting the water receptacles 22 in accelerating the drive system 50 to the operational rotation speed.

FIG. 5 shows a schematic plan view of hydroelectric generator apparatus 10 floating on a river. The hydroelectric generator apparatus 10 shown in FIG. 5 is a trimaran-style structure having three buoyant hulls, two outboard hulls 14a and a single central hull 14b. The hulls are positioned in parallel with the central hull 14b located centrally with each outboard hull 14a located on opposing sides of the central hull 14b. The central hull 14b is the largest (for example the longest and/or the widest) which beneficially increases the stability of the hydroelectric generator apparatus 10 whilst also allowing two sets of hydroelectric turbine modules 70 to be connected to and supported by the hull structure in parallel, thus doubling the effective energy generating capacity.

The trimaran style hull structure is beneficial as it allows hydroelectric turbine modules 70 comprising the chassis 12 and drive system 50 to be fitted between the respective hulls 14a, 14b. The turbine modules 70 are modular turbine units comprising hydroelectric generator apparatus 10 as shown in FIG. 1 wherein each turbine module 70 comprises two-spaced apart pulley wheels 16 and the chain 20 or endless loop connected to the water receptacles 22. Each turbine module 70 may be housed within a modular unit such that each turbine module 70 may be easily fitted and removed from trimaran hull structure. Advantageously, each turbine module 70 may be easily fitted to or removed from the trimaran style hull by decoupling the turbine module 70 from the drive shaft 46 thereby facilitating easy maintenance or replacement of an individual turbine modules 70.

As shown in FIG. 5 the central hull 14b comprises the generator 43 and flywheel 42. The flywheel 42 is connected to each turbine module 70 by the drive shaft 46 such that rotation of the water receptacles 22 within the turbine module 70 drives the flywheel 42 and thus generator 43 in the central hull 14b. The turbine module 70 shown in FIG. 5 comprises water receptacles 22 as described above such that the movement of the water receptacles 22 being driven by the flow of the water in turn drives the drive shaft 46 and the generator 43. The central hull 14b may comprise vertically extending slots in the side of the hull 14b such that the drive shaft 46, and thus turbine module 70 may be easily lowered and lifted into position. The flywheel gear 45 may be removably coupled to the drive shaft 46 by a universal joint or the like to facilitate easy fitment and removal of the turbine module 70.

Each hull 14a, 14b may further comprise ballast tanks 56. The ballast tanks 56 are positioned at proximal and distal ends of the respective hulls 14a, 14b and are configured to be selectively flooded so as to control the height of the hydroelectric generator apparatus 10 in the water. A bilge pump (not shown) may be located in each hull 14a, 14b to pump water into and out of each ballast tank 56 thereby controlling the height of the apparatus 10 in the water. This is beneficial as it allows the water flow to the water receptacles 22 of the turbine modules 70 to be controlled. When the ballast tanks 56 are empty the water receptacles 22 may be raised completely from the water such that the drive system 50 is not being driven. This may allow, for example, maintenance of the turbine modules 70 to be conducted. Furthermore, the ballast tanks 56 allow the depth that the water receptacles 22 are submerged below the water level W to be controlled depending on the river conditions. This is beneficial as it allows the amount of force that is applied to the water receptacles 22 by the river flow to be controlled by controlling the level of submergence of the water receptacles 22.

Each outer hull 14a are pivotally coupled to the central hull 14b by arms 54 connected to pivots 52. The pivots 52 allow the outer hulls 14a to be pivoted relative to the central hull 14b such that the outer hulls 14a are moveable between a deployed position (as shown in FIG. 5) and a stored position (as shown in FIG. 6). When the outer hulls 14a are in the deployed position the outer hulls 14a are positioned outboard of the central hull 14b. Furthermore, when in the deployed position the outer hulls 14a extend generally parallel to the central hull 14b and the arms extend generally perpendicularly from the central hull 14b.

FIG. 6 shows and end view of the hulls 14a, 14b in isolation with the turbine modules 70 removed. The hulls 14a, 14 are shown in the stored position in FIG. 6, as would be typical when transporting the hull structure to a river site prior to installation of the hydroelectric generator apparatus 10. When the outer hulls 14a are in the stored position the outer hulls 14a may be pivoted upwardly relative to the central hull 14b such that the outboard hulls 14a are positioned above the central hull 14b. This is beneficial as moving the outboard hulls to the folded position reduces the overall footprint of the hull structure. This is particularly beneficial for transporting the hull structure from a manufacturing site to a river site. When the hull structure, comprising the two outer hulls 14a and central hull 14b, is transported to the river site the outer hulls 14a may be pivoted to the deployed position.

Further structural bracing may be fitted when the outer hulls 14a are moved to the deployed position to secure the outer hulls 14a in the deployed position relative to the central hull 14b. The further structural bracing may form part of the chassis 12 and can be used to mount the hydroelectric generator apparatus 10, comprising the drive systems 50, relative to the hulls 14a, 14b. The skilled reader will appreciate that the further structural bracing is not shown in FIG. 5 or FIG. 6 for clarity.

The central hull 14b may be about 10 m wide and about 30 m in length. Similarly, the outer hulls 14a may be around 30 m in length and about 5 m wide. The central hull 14b may have multiple floors or levels within the hull 14b.

The trimaran hull design shown in FIG. 5 and FIG. 6 is beneficial as the hull structure may be used to house further energy generation apparatus. For example, the outer hulls 14a may comprise one or more electrolyser units powered by the generator 43. Furthermore, the outer hulls 14a may be used as storage tanks for hydrogen produced by electrolysis. Using the hydroelectric generator apparatus 10 for hydrogen generation is beneficial as the key components, namely: water and electricity, are found in abundance at the river site where the hydroelectric generation apparatus 10 is positioned in use.

Furthermore, the outer hull 14a and/or central hull 14b may comprise filtration units to filter the water prior to electrolysis. The water used for hydrogen production may be taken from the river and subsequently filtered and/or may be rainwater that falls on the roof covering of the turbine modules 70 and what may fall on the central hull 14b. This is beneficial as filtering the water prior to electrolysis ensures that high quality hydrogen is produced.

The trimaran hull structure may further comprise batteries and/or super capacitors. The hull structure may be fitted with one or more solar panel arrays which may be used to charge the batteries. The batteries may be used to power subsidiary functions on the hydroelectric generator apparatus 10. For example, they may be used to power the starter motor, to drive the generator 43 as a motor to start the turbine, to drive the bilge pumps, filtration of water prior to electrolysis. Furthermore, the batteries may be used to supplement the electricity supplied to the electrolysis units by the generator 43 to ensure that the voltage and current requirements of the electrolysis units are met. The generator 43 may be used to charge the batteries and/or super capacitors in which case the voltage requirements of the electrolysis units may be supplied entirely by the batteries and/or super capacitors.

It will be appreciated that the hydroelectric generator apparatus 10 of the present invention can be scaled according to specific requirements, including the size of the river within which it is deployed. For example, small-scale “micro” hydroelectric generators may be deployed in smaller rivers, or where local energy generation requirements are smaller; whereas large-scale “macro” hydroelectric generators may be deployed in larger rivers, or where local energy generation requirements are higher. In either case, the hydroelectric generators may be deployed as an array or “flotilla” of multiple such generators each independently generating electricity which feeds a common electrical substation on a riverside location. In this way, the natural and continuous energy potential of flowing water can be re-used multiple times without limitation. It will be appreciated that this form of renewable energy is—except in time of severe drought—continuously available unlike solar and wind alternatives which are heavily reliant on optimum weather conditions. Furthermore, since population conurbations and industries have, for historic reasons, located themselves along river networks the electricity generated by the hydroelectric generator apparatus of the present invention will find demand locally, thus avoiding the need for expensive, long distance distribution networks.

Although a particular embodiment of the invention has been disclosed herein in detail, this has been done by way of example and for the purposes of illustration only. The described embodiment is not intended to be limiting with respect to the scope of the appended claims. Indeed, it is contemplated by the inventor that various substitutions, alterations, and modifications may be made to the invention without departing from the scope of the invention as defined by the claims. Examples of these are described below.

Whilst the described and illustrated example discloses a chassis supported by two parallel buoyant hulls arranged side by side, other arrangements are not precluded. For example, a trimaran-style structure having three buoyant hulls arranged side-by-side, with the central hull being longest, may increase stability of the apparatus whilst also allowing two sets of hydroelectric generators to be connected to the chassis in parallel, thus doubling the effective energy generating capacity.

In some embodiments, each buoyant hull of a multi-hulled structure may be connected together at its fore and aft ends. Such connections prevent or resist twisting distortions and hence improve the structural rigidity of the apparatus, thus ensuring that it can remain operational in adverse conditions such as high winds, waves and currents. It will be appreciated that, if the apparatus of the present invention is scaled to a sufficient size, the upper surfaces of each buoyant hull and/or its crosswise connecting members may take the form of walkways permitting personnel to access different parts of the apparatus for maintenance and repair purposes.

Conveniently, a connection between adjacent hulls at the fore end of the structure can be adapted—e.g. by providing a skirt projecting down to the waterline—to provide a physical barrier to floating debris thus preventing its entry into the U-shaped channel area(s) beneath the chassis.

In some embodiments, a shutter system may be connected to the U-shaped channel proximate its upstream entrance for selectively permitting and preventing the flow of water therethrough. The shutter may comprise a series of interconnected pivotable louvre elements for opening and closing the upstream entrance of the U-shaped channel. It will be appreciated that the ability to prevent waterflow through the U-shaped channel—and hence cease electricity generation—will be useful when, for example, the hydroelectric generator is being moved to/from a deployed position on a river; whilst it is undergoing maintenance or repair; or when it requires to be deactivated during extreme, adverse weather conditions. Furthermore, the ability to slowly open and close the shutter will allow the generator to be activated and deactivated in a controlled and gradual manner.

Although the apparatus of the illustrated embodiment has been described as operating within a flowing river, the hydroelectric generator of the present invention can also be deployed in other environments such as a tidal estuary. In such a circumstance, and provided additional safeguards are employed for compliance with local marine navigation laws, the hydroelectric generator may be tethered to the seabed at a single point with the ability to self-align with the alternating current by pivoting back and forth around a 180 degree angle.

In some embodiments, there may be provided a chain 20 adjustment mechanism for ensuring optimal alignment and tensioning of the chain 20 relative to the cogged or toothed pulley wheels 16. Such a mechanism facilitates adjustments to avoid jamming of the chain 20 as it engages with the pulley wheels 16

Although the apparatus of the illustrated embodiment has been described as including a cogged or toothed pulley wheel engageable with a chain, it will be appreciated that alternative means of transferring mechanical torque across axles are not excluded. For example, the pulley wheel may be provided with grooves, ribs or other surface features which promote frictional engagement with a suitable drive element. Indeed, a smooth pulley wheel which a sufficient coefficient of friction is not excluded. As an alternative to a chain, other drive elements may be employed such as cables or belts.

In some embodiments the trimaran hull structure, the like of which is illustrated in FIG. 5, may be used as a pleasure craft. For example, the hull structure may comprise an array of batteries which can be charged by the turbine modules 70 when the hull structure is moored on a river. When the batteries have sufficient charge the turbine modules 70 may be operated in reverse such that the turbine modules 70 provide a drive force to propel the hull structure along the river. Each turbine module may be operated independently so as to allow the trimaran hull structure to be steered. Furthermore, a rudder may also be fitted to the hull structure to allow the hull structure to be manoeuvred when being operated as a pleasure craft.

Operating the turbine modules 70 as propulsion systems is beneficial as it allows the hull structure to be easily moved. For example, if maintenance is required on the hydroelectric generator apparatus 10 the turbine modules 70 could be operated so as to propel the apparatus 10 to a dock. Alternatively, the turbine modules 70 may be used primarily for a re-chargeable electric pleasure craft. In this embodiment the trimaran hull structure could be moored during the week to charge the batteries, for example, and at weekends a user of the craft could use the electricity generated by the turbine modules 70 to propel the craft.

1. A hydroelectric generator assembly comprising:
(i) a floatable chassis:
(ii) at least two spaced-apart rotational axles attached to the floatable chassis, each adapted to remain, in use, above the surface of a flowing body of water;
(iii) an electrical generator mounted on the floatable chassis and coupled to at least one of the rotational axles;
(iv) an endless loop connected to the rotational axles;
(v) a plurality of water receptacles fixed to the endless loop, and each being orientated, when submerged, to present major openings towards an oncoming waterflow direction;
(vi) a plurality of minor openings being provided through a wall of each water receptacle;
(vii) a valve member located on each water receptacle for controlling passage of water through said minor openings;
wherein the valve member is adapted to selectively permit flow of water through said minor openings into each water receptacle but substantially prevent flow of water through said minor openings out of each water receptacle.

2. A hydroelectric generator assembly according to claim 1, wherein the floatable chassis is supported in the water by at least two parallel buoyant hulls arranged side by side.

3. A hydroelectric generator assembly according to claim 1, wherein each water receptacle is provided with at least one concave inner surface and at least one convex outer surface.

4. A hydroelectric generator assembly according to claim 3, wherein said plurality of minor openings are in the form of an array of apertures formed through a portion of the water receptacle between its said inner and outer surfaces.

5. A hydroelectric generator assembly according to claim 4, wherein the valve member comprises a flap hingeably attached to an interior surface of its water receptacle and moveable between: (i) a first position in which it covers said minor openings to cause flow of water therethrough to be prevented; and (ii) a second position in which said minor openings are uncovered to permit flow of water therethrough.

6. A hydroelectric generator assembly according to claim 5, wherein an edge of the flap is attached to the water receptacle proximate an edge of its major opening.

7. A hydroelectric generator assembly according to claim 6, wherein the flap is attached to the water receptacle proximate the edge of its major opening which is most distant from the endless loop.

8. A hydroelectric generator assembly according to claim 5, wherein the flap comprises a flexible sheet of material.

9. A hydroelectric generator assembly according to claim 1, wherein pulley wheels are attached to opposite ends of each rotational axle.

10. A hydroelectric generator assembly according to claim 9, wherein the endless loop comprises a chain, belt or cable which engages with, and transfers movement to, each pulley wheel and its associated axle.

11. A hydroelectric generator assembly according to claim 1, wherein a substantially U-shaped channel is attached to the floatable chassis and adapted to remain, in use, at least partially below the surface of a flowing body of water.

12. A hydroelectric generator assembly according to claim 11, wherein a base of the U-shaped channel is located beneath each submerged water receptacle, and its opposed side walls extend above the surface of a flowing body of water.

13. A hydroelectric generator assembly according to claim 11, wherein, the width of the U-shaped channel at both an upstream entrance and a downstream exit thereof is larger than its width at an interim portion between said upstream entrance and downstream exit.

14. A hydroelectric generator assembly according to claim 1, wherein the floatable chassis is provided with a tether for anchoring the hydroelectric generator in desired location within a flowing body of water.

15. A method of generating hydroelectric power, comprising:
(i) deploying a hydroelectric generator according to claim 1 to a desired location within a flowing body of water;
(ii) tethering said hydroelectric generator at said desired location;
(iii) permitting water to flow into a plurality of submerged water receptacles and thereby close the valve members located therein and thus prevent flow of water through said minor openings out of each water receptacle;
(iv) transferring force to the endless loop causing it, and its associated rotational axles, to rotate; and
(v) causing the electrical generator to convert the kinetic energy imparted on the axles, via the water receptacles and endless loop, into electricity.

16. A hydroelectric turbine assembly, the turbine assembly comprising:
a turbine module wherein the turbine module comprises:
two spaced-apart rotational axles; and
an endless loop connected to the rotational axles wherein a plurality of water receptacles are fixed to the endless loop and each being orientated, when submerged, to present major openings towards an oncoming waterflow direction;
a flywheel comprising a drive shaft mechanically coupled to each rotational axle; and
a generator comprising a generator shaft wherein the generator shaft is coupled to the flywheel such that rotation of the flywheel drives the generator shaft.

17. A hydroelectric turbine assembly as claimed in claim 16, wherein the assembly comprises a central hull and outboard hulls positioned on opposing sides of the central hull and wherein respective gaps are defined between each outboard hull and the central hull.

18. A hydroelectric turbine assembly as claimed in claim 17, wherein the central hulls and outboard hulls are elongate and wherein the elongate hulls are oriented substantially parallel relative to each other.

19. A hydroelectric turbine assembly as claimed in claim 17, wherein the outboard hulls are pivotably mounted to the central hull such that the outboard hulls are moveable between a deployed position in which the outboard hulk are positioned outboard of the central hull and a stored position in which the outboard hulls are positioned above the central hull.

20. A hydroelectric turbine assembly as claimed in claim 17, wherein the flywheel and generator are mounted in the central hull.

21. A hydroelectric turbine assembly as claimed in claim 20, wherein the flywheel is mounted in the central hull at a mid-point longitudinally between the two-spaced apart axles.

22. A hydroelectric turbine assembly as claimed in claim 17, wherein the drive shaft extends from opposing side walk of the central hull towards the respective outboard hulls.

23. A hydroelectric turbine assembly as claimed in claim 22, wherein the assembly comprises two turbine modules and wherein each turbine module is supported in a respective gap between the outboard hull and the central hull.

24. A hydroelectric turbine assembly as claimed in claim 16, wherein a drive chain couples each rotational axle to a flywheel gear on the drive shaft.

25. A hydroelectric turbine assembly as claimed in claim 24, wherein each drive chain is coupled to a drive gear on each rotational axle.

26. A hydroelectric turbine assembly as claimed in claim 25, wherein the gear ratio between the drive gear and the flywheel gear is between 10:1 and 50:1.

27. A hydroelectric turbine assembly as claimed in claim 16, wherein a flywheel belt couples the flywheel to the generator shaft.

28. A hydroelectric turbine assembly as claimed in claim 27, wherein the flywheel belt extends at least partially around an external surface of the flywheel and wherein the flywheel belt is coupled to a generator gear.

29. A hydroelectric turbine assembly as claimed in claim 28, wherein a gear ratio from the flywheel to the generator gear is equal to or greater than 10:1.

30. A hydroelectric turbine assembly as claimed in claim 16, comprising a starter motor configured to apply a starter torque to the flywheel to rotate the flywheel.

31. A hydroelectric turbine assembly as claimed in claim 30, wherein the generator is the starter motor.

32. A hydroelectric turbine assembly as claimed in claim 17, wherein at least one of the outboard hulls comprises an electrolysis unit for producing hydrogen.

33. A hydroelectric turbine assembly as claimed in claim 18, wherein at least one of the outboard and central hulls comprises a battery array.

34. A hydroelectric turbine assembly as claimed in claim 33, wherein the battery array is configured to provide a drive torque to the endless loop to drive the water receptacles to move the turbine assembly through water, in use.
